(19) United States
(12) Patent Application Publication
(10) Pub. No.: US 2025/0020567 A1
(43) Pub. Date: Jan. 16, 2025

(54) SINGLE-PARTICLE INDUCTIVELY-COUPLED PLASMA MASS SPECTROMETRY PARTICLE SIZING AND COUNTING METHOD, SYSTEM, COMPUTER PROGRAM AND COMPUTER-READABLE DATA CARRIER

(71) Applicant: ECOLE POLYTECHNIQUE FEDERALE DE LAUSANNE (EPFL), Lausanne (CH)

(72) Inventor: Cedric David KOOLEN, Sion (CH)

(21) Appl. No.: 18/713,037

(22) PCT Filed: Nov. 23, 2022
(86) PCT No.: PCT/IB2022/061334

§ 371 Date: May 23, 2024

(30) Foreign Application Priority Data
Nov. 26, 2021 (EP) 21210751.0

(51) Int. Cl. G01N 15/10; H01J 49/00; H01J 49/10

(52) U.S. Cl. CPC G01N 15/10; H01J 49/0009; H01J 49/0036; H01J 49/105; G01N 2015/1024; G01N 2015/1029

(57) ABSTRACT

The invention concerns a single-particle inductively-coupled plasma (ICP) mass spectrometry particle sizing and counting method comprising providing or receiving an intensity-versus-counts histogram of particles detected using an ICP mass spectrometer, the intensity representing particle detection and the count representing particle detection frequency; providing or receiving mass flux calibration data or calibration curve data relating a value of the intensity measurement or data of the ICP mass spectrometer to a mass of material detected per acquisition interval or dwell time; determining a particle mass of the particles detected using the mass flux calibration data or the at least one mass flux calibration curve data, determining a particle volume of the detected particles using the determined particle mass, and determining a particle size of the particles detected using the determined particle volume of the particles detected and a determined or attributed geometry or shape of the detected particles.

### CROSS-REFERENCE TO RELATED APPLICATIONS

The present application claims priority to European patent application EP21210751.0 filed on Nov. 26, 2021, the entire contents thereof being herewith incorporated by reference.

### FIELD OF THE INVENTION

The present disclosure relates to particle sizing and particle counting using single-particle inductively-coupled plasma mass spectrometry. The present disclosure relates to particle sizing and counting of inorganic nanoparticles, for example, to particle sizing and counting of anisotropic or isotropic polyelemental (containing more than one element in a single nanoparticle) inorganic nanoparticles.

### BACKGROUND

Nanoparticle size and shape have shown to play an important role in a variety of physical and chemical processes including light-matter interactions, magnetism, (electro)catalysis etc.^{1,2,3,4} To determine structure-property relations for such phenomena, accurate and precise description of size and shape is obligatory. Traditionally, nanomaterials are sized through the production of SEM and or TEM micrographs and subsequent edge-length analysis.^{5,6} Several commercial and or open-source software image processing packages exist that can be of aid herein.^{7,8,9}

However, such automated sizing approaches have not yet found wide rapport as image processing techniques suffer from poor image contrast, particle clustering and cannot distinguish between different elements or phases. Automated sizing success is often frustrated by tedious sample preparation steps and large quantities of micrographs needed for reasonable statistics.^{9,10} Therefore, more often than not, researchers fall back on old-fashioned manual particle counting instead, which is prone to bias.

Born out of an aversion for particle counting and with the goal of addressing the previously mentioned inconveniences of the prior art, the inventors have developed a one-size-fits-all method or protocol to simultaneously size and count, for example, several thousands of inorganic nanoparticles and nanocrystals in a matter of minutes, independent of size, shape, and element, based on single-particle inductively-coupled plasma mass spectrometry (SP-ICP-MS).

### SUMMARY

It is therefore one aspect of the present disclosure to provide a single-particle inductively-coupled plasma mass spectrometry particle sizing and counting method. The method comprises:
providing or receiving an intensity (Iₚ)-versus-counts (Cts) histogram of particles detected using an inductively-coupled plasma mass spectrometer (ICP-MS) the intensity (Iₚ) representing particle detection and the count (Cts) representing particle detection frequency,
providing or receiving mass flux calibration data or at least one mass flux calibration curve data relating a value of the intensity (Iₚ) measurement or data of the inductively-coupled plasma mass spectrometer to a mass of material detected per acquisition interval or dwell time,
determining a particle mass (mₚ) of the particles detected using the mass flux calibration data or the at least one mass flux calibration curve data,
determining a particle volume (Vₚ) of the detected particles using the determined particle mass (mₚ) and determining a particle size of the particles detected using the determined particle volume (Vₚ) of the particles detected and a determined or attributed geometry or shape of the detected particles.

Specific embodiments and other advantageous features can be found in the dependent claims.

As known to the skilled person in the art, the inductively-coupled plasma mass spectrometer is configured to use an inductively-coupled plasma to atomize and ionize samples to be analyzed and to carry out inductively-coupled plasma mass spectrometry.

The inductively-coupled plasma mass spectrometer may include, for example, a peristaltic pump and a nebulizer for sample introduction and aerosol production, an inductively-coupled plasma torch, configured to generate an inductively-coupled plasma, and a mass spectrometer, comprising of a mass analyzer such as a quadrupole or time-of-flight tube and an ion detector such as an electron multiplier, configured to select and detect ions based on their mass-to-charge ratio.

Single-particle inductively-coupled plasma mass spectrometry is used to measure and provide a detected signal representing the detection of particles over a given period/interval by the detector of the inductively-coupled plasma mass spectrometer. A background signal is then removed from the measured particle detection data to provide an intensity Iₚ-versus-counts histogram of particles detected.

Dissolved metal calibration data or a dissolved metal calibration curve relating a measured intensity to concentration is measured using the inductively-coupled plasma mass spectrometer and is converted to a mass flux calibration data or a mass flux calibration curve data. This is used to calculate a particle mass mₚ of the particles detected and a particle volume Vₚ. The known geometry or shape of the particles and the calculated particle volume Vₚ is used to calculate particle size and a particle size distribution. Measured SP-ICP-MS data and measured or known particle properties are used to calculate a particle size distribution. Further details are provided below in the detailed description.

This innovative technique of the present disclosure is entirely void of bias as every single particle is counted. Using developed syntheses, the inventors show the capabilities of SP-ICP-MS to size and count, for example, (an)isotropic (bi)metallic nanoparticles including but not limited to spheres, cubes, tetrahedra and truncated octahedra (FIG. 1).

As shown in the panels of FIG. 1, excellent agreement is found between the particle size and particle size distribution determined by the present invention (SP-ICP-MS panels B1 to B3 of FIG. 1) and conventional sizing data (low-resolution transmission electron microscopy (LR-TEM) panels C1 to C3 of FIG. 1). Furthermore, aggregates in the sample are observed (counts at the far end of the distributions) which are missed by TEM, giving a more complete picture of the ensemble without bias.

This method according to the present disclosure is expected to find use in, amongst others, materials science, materials chemistry, (nano)physics, (nano)photonics, (photo)catalysis and electrochemistry.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows, in panels A1, A2, A3, TEM micrographs of cubic (C), truncated octahedral (TOh), and tetrahedral (Th) Cu nanocrystals synthesized using a phosphine-derivative mediated wet-chemical procedure, Scale-bar=200 nm. Panels B1, B2, B3 of FIG. 1 show size-distributions obtained of the C-, TOh- and Th-Cu nanocrystals using SP-ICP-MS and the method of the present disclosure. The particle most frequently observed had an edge-length of: 77, 15 and 77 nm, respectively. Edge-length is defined as the center-to-center distance between two corner atoms of a particle (depicted in the darkest shade in the ball models in the inset, some of which are indicated by dashed arrows). The total number of particles observed was >1000 for each measurement of 100 sec duration. Panels C1, C2, C3 of FIG. 1 show size-distributions of 100 C-, TOh- and Th-Cu nanocrystals using particle counting using LR-TEM images. Excellent agreement exists between the SP-ICP-MS method of the present disclosure and conventional sizing data shown in panels C1, C2, C3 of FIG. 1. Furthermore, aggregates in the sample are observed (counts at the far end of the distributions) missed by TEM, giving a more complete picture of the ensemble without bias.

FIG. 2 shows a general approach according to the present invention to obtaining size-distributions of nanoparticle dispersions using SP-ICP-MS and the method according to the present disclosure. FIG. 2A shows a nanoparticle (NP) aerosol formed after nebulization of the sample dispersions. FIG. 2B shows a plasma torch of the ICP-MS instrument used for the atomization and ionization of the particles in the aerosol. FIG. 2C shows SP-ICP-MS raw data containing both background signal (dissolved ions) and particle events (ion plumes). FIG. 2D shows a histogram of the raw data obtained via, for example, a sorting algorithm after background subtraction equating the intensity to the number of observations (counts). FIG. 2E shows a final solution of SP-ICP-MS data processing pipeline.

FIG. 3 shows instrument calibration and data processing steps. FIG. 3A shows an intensity versus time plot of the SP-ICP-MS raw data of a calibrant (top) and analyte (bottom). FIG. 3B shows an intensity-versus-counts histogram of a calibrant (top) and analyte (bottom). FIG. 3C shows a transport efficiency (ηₜ) calibration curve of particle dispersions of known size and number concentration (in the present disclosure Au NP are used for example but not limited thereto (see also below and FIGS. 9 and 10)). FIG. 3D is a standard solution calibration curve (dissolved Cu for example in the present disclosure but not limited thereto). FIG. 3E is a converted mass/interval calibration curve of the dissolved ion standard (for example, dissolved Cu in the present disclosure but not limited thereto). FIG. 3F shows various geometrical models to extract dimensional parameters such as edge-length including but not limited to spheres, cubes, truncated octahedra and tetrahedra. FIG. 3G shows a final solution of the SP-ICP-MS data processing pipeline but is not limited thereto.

FIG. 4A is a schematic of dissolved metal solutions prepared from ion standards of known concentrations. FIG. 4B shows the average intensity measured for each individual standard solution. FIG. 4C shows the dissolved metal calibration curve relating the measured intensity to the concentration. FIG. 4D shows the mass flux calibration curve relating the intensity to the mass per dwell.

FIG. 5 shows exemplary sample preparation and solvent transfer via surfactant stripping using triethyl oxonium hexafluorophosphate. FIG. 5A is a schematic representation of the surfactant stripping. FIG. 5B shows ball models of the synthesized anisotropic nanocrystals: cube (C), truncated octahedra (TOh) and tetrahedra (Th), respectively. The coloring of the surface atoms describes their specific nature. Darkest tone: corner atoms with coordination numbers (CN)<6, one tone lighter: edge atoms with CN<9, second lightest tone: Cu(100) and finally the lightest tone: Cu(111). FIG. 5C shows TEM micrographs of the as-synthesized anisotropic nanocrystals capped with their native surfactants: oleylamine, trioctylphosphine, trioctylphosphine oxide. FIG. 5D shows partially edged crystals as a result of too high Meerwein's salt concentrations during the surfactant stripping reaction. FIG. 5E shows PF₆_{^{−}} stabilized, surface intact nanocrystals dispersible in any polar solvent including water, methanol (MeOH), ethanol (EtOH), isopropanol (iPrOH), dimethyl formamide (DMF) but not limited thereto.

FIGS. 6A, 6AA, 6B, 6BB, 6C and 6CC show a dilution series of TOh Cu nanoparticles. Number concentration (N): 10⁵, ⅓·10⁵ and ⅙·10⁵ NP/mL. Shift of the average mass to lower values as evidenced by the value of the most frequent observed size shows the particle concentration problem. If N is too high and the background is too high, ion plumes derived from initial particles arrive at the detector at such short intervals that their mass cannot be resolved and are, therefore, assigned to the same particle event. Optimization and calibration of N is instrumental to correct mass assignment. This feature perseveres even with an independent instrument calibration used. The gain in the number of counts is evidence that multiple particle events are excluded and particle events can be fully resolved.

FIG. 7 shows SP-ICP-MS of the present disclosure as a method to characterize anisotropic nanosurface alloys (NSA).¹¹ The Cu-cube nanocrystals synthesized in the present disclosure were coated with an ultrathin shell of Ag using a galvanic exchange reaction (see below, FIGS. 9 and 10). FIGS. 7A1-7A2 show TEM micrographs of the Cu cubic core and the CuAg cubic NSA, respectively. FIGS. 7B1-7B2 show Cu and Ag mass flux calibration curves used to quantify signal/dwell. FIG. 7C1 shows that using a subsurface model (FIG. 14), the Cu particle mass distribution obtained with SP-ICP-MS can be converted into an ensemble distribution of surface atoms. FIG. 7C2 shows a distribution of Ag atoms obtained via SP-ICP-MS. By taking the ensemble average, the inventors deduct that 0.59 monolayer of Ag has been deposited. Inset shows the normally distributed doping concentration of Ag.

FIG. 8 shows, in FIGS. 8A1-8A3, TEM micrographs of C-CuAg, C-CuPd, and C-CuPdAg multimetallic NPs, respectively. FIGS. 8B1-8B3 show STEM-EDX elemental maps of C-CuAg, C-CuPd, and C-CuPdAg NPs. FIGS. 8C1-8C3 show normalized composition distributions of C-CuAg, C-CuPd, and C-CuPdAg multimetallic NPs obtained with a TOF mass analyzer. The C-CuAg and C-CuPdAg distributions were normalized by the number of events. The C-CuPd distribution was normalized so that the probability density function integral equaled to one. In FIG. 8C1, the C-CuAg distribution shows that Ag is normally distributed around the mean, corroborating the results obtained using the quadrupole (Gaussian fit: R²=0.9723). In FIG. 8C2, the C-CuPd is lognormally distribution evidenced by the positive skew (R²=0.9816), and in FIG. 8C3 the C-CuPdAg distribution shows again a normal distribution (R²=0.9467).

FIG. 9 shows NanoComposix Au standard particle samples: 61, 78 and 98 nm. 50,000 NPs/mL.

FIG. 10 shows PerkinElmer standard Au samples: 30, 50 and 80 nm. 50,000 NPs/mL.

FIG. 11 shows a Cu dissolved standard calibration curve.

FIG. 12 shows a dilution series Th using calibrants of FIGS. 9 and 10.

FIG. 13 shows surface atom compositions of Th and TOh CuAg surface alloy nanocrystals as determined by SP-ICP-MS.

FIG. 14 shows a ball model describing the subsurface approach to the determination of the number of surface atoms. The surface atoms in the geometrical model consist of a single monolayer.

FIG. 15 schematically shows exemplary steps of the single-particle inductively-coupled plasma mass spectrometry particle sizing and counting method of the present disclosure.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

Routine inductively-coupled plasma mass spectrometry (ICP-MS) is used to determine metal concentrations of ion solutions. In the framework of nanomaterials, this entails the digestion of particulate matter using strong acids such as nitric acid (HNO₃), hydrochloric acid (HCl) or aqua regia yielding dissolved ion solutions of the respective materials. Detected based on their mass-to-charge ratio, ion intensities can be related to element specific, absolute concentrations via so-called calibration curves based on elemental standard solutions of known concentration.¹² This allows for the determination of elemental make-up, synthesis yields, dispersion concentrations etc. Multiple intensity readings are often acquired and averaged over long acquisition intervals, or dwell times (ms to s) to obtain time averaged ion concentrations improving signal to noise.

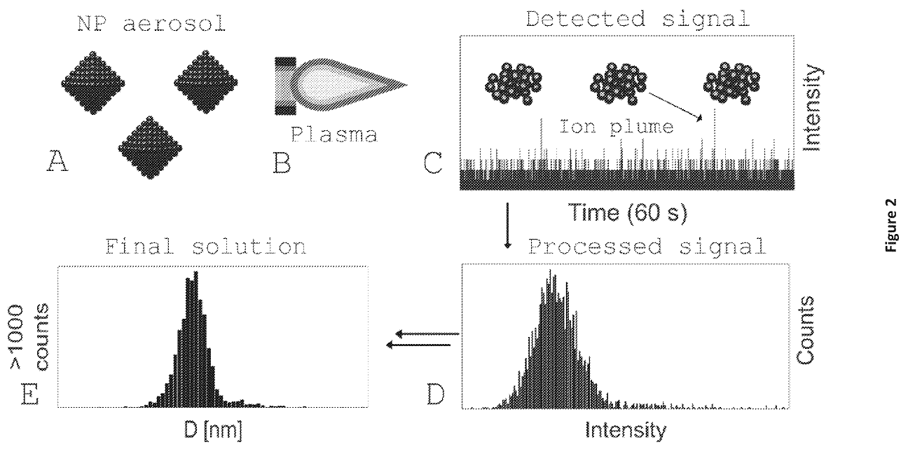

In contrast, in single-particle inductively-coupled plasma mass spectrometry (SP-ICP-MS), undigested dispersions are nebulized and introduced to the plasma torch directly, after which individual particles become atomized and ionized, and arrive at the mass analyzer as discrete ion packages, or ion plumes (see for example FIG. 2).¹³ This is distinctively different from dissolved ion intensities, or background signal. Intensity spikes above the background herald the arrival of an ion plume or particle event at the detector. To distinguish between these discrete particle events and the dissolved ions, acquisition times much shorter than ICP-MS are needed (μs-ms). Each individual acquisition of the intensity read-out (per dwell time) is then plotted against time obtaining the SP-ICP-MS raw data (FIG. 2C).

With a sorting algorithm, combined with a mathematical background subtraction process, histograms, relating a given intensity to number of times it has been observed, are produced. Each intensity is then related to the number of ions in the plume, and thereby the mass of the initial particle ionized, and the frequency, or counts, to the number of times a particle of that specific mass has been observed. With a known particle geometry, the particle mass can then be converted, using the density, into a particle size. Further, the total number of counts is directly proportional to the number concentration. Several steps have to be executed, however, before raw SP-ICP-MS data can be transformed into a meaningful data-set such as a size-distribution.^{14,15} Traditionally, SP-ICP-MS has been used to determine particle concentrations and size distributions of poorly defined, crude dispersions relevant to environmental research, health and or food sciences, limited to metal oxides and noble metals such as Au, Ag, and Pt.^{16,17, 18, 19,13}

In contrast, the inventors present a generalized quantitative method to use SP-ICP-MS to accurately describe and characterize well-defined inorganic nanoparticles of various size, shape and compositions independent of elemental make-up and with high precision, complementary to electron microscopy. A detailed description of the method according to the present disclosure is now provided, and in particular of the instrument calibration and data processing pipeline. Steps S1 to S5 of the single-particle inductively-coupled plasma mass spectrometry particle sizing and counting method of the present disclosure are schematically shown in FIG. 15.

The method comprises providing or receiving (S1) an intensity Iₚ versus-counts Cts histogram of particles detected using an inductively-coupled plasma mass spectrometer ICP-MS. The histogram may, for example, be provided or received as data representing the histogram that can then be processed. The intensity Iₚ represents particle detection and the count Cts represents particle detection frequency. Mass flux calibration data or at least one mass flux calibration curve data relating a value of the intensity Iₚ measurement or data of the inductively-coupled plasma mass spectrometer to a mass of material detected per acquisition interval or dwell time is also provided or received (S2).

A particle mass mₚ of the particles detected using the mass flux calibration data or the at least one mass flux calibration curve data is determined or calculated (S3). A particle volume Vₚ of the detected particles is determined or calculated (S4) using the determined particle mass mₚ. A particle size of the particles detected is determined or calculated (S5) using the determined particle volume Vₚ of the particles detected and a determined or attributed geometry or shape of the detected particles. Inductively-coupled plasma mass spectrometers are known and detailed in, for example, Thomas 2003²⁰, the entire contents of which are hereby incorporated by reference.

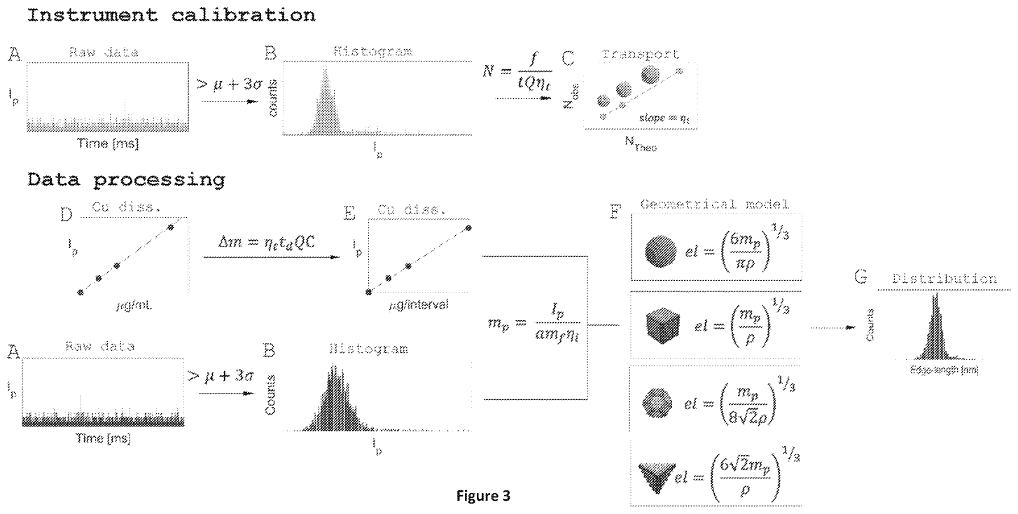

FIG. 3 shows more details and shows exemplary steps of the method of the present disclosure, and in particular shows instrument calibration and data processing steps.

As described previously, SP-ICP-MS data consists of an intensity as a function of time (FIG. 3A). This includes a background signal of, for example, trace metal ions and particle events evidenced by spikes in the intensity above the background. In order to extract all particle events, background subtraction is performed. This is, for example, achieved mathematically by averaging over all intensities and determining the standard deviation (σ). A particle event is then, for example, defined as any intensity 3σ (for example) above the background.^{21,22} This is done iteratively. After the first set of particle events has been collected, the σ of the new data-set is determined and the process repeated until no signal >3σ remains. All extracted particle events are than sorted based on their respective intensity values, and reported as a counts-versus-intensity histogram (FIG. 3B). An intensity Iₚ versus-counts Cts histogram of particles detected using an inductively-coupled plasma mass spectrometer ICP-MS is thus provided or received (S1) as part of the present method.

The intensity (Iₚ)-versus-counts (Cts) histogram is provided by obtaining or measuring intensity (Iₚ) measurements representing particle detection as a function of time using the inductively-coupled plasma mass spectrometer, and removing a background intensity signal from the intensity (Iₚ) measurements as a function of time. The removing of the background signal is, for example, carried out by averaging over all intensity values and determining a standard deviation σ, and defining a particle detection as any intensity value that is, for example, at least 3 times the standard deviation σ+ the mean μ above a background intensity value, and arranging the particle detections based on their respective intensity values and as a counts-versus-intensity histogram.

The total number of counts is a direct measure of the number of particles that have reached the detector, which can be converted into a number concentration using Eq. 1:

$$N = \frac{f}{Qt}$$

in which N is the number concentration (NPs/mL), ƒ the number of counts per acquisition (cts), t the total acquisition time (s) and Q the sample flow rate (mL/ms), which can, for example, be estimated from the mass change of an arbitrary volume of water consumed by the instrument as a function of time.

Determining the sample flow rate is a calibration step for any instrument and may vary based on, for example, the peristaltic pump used, tube inner diameter, tube elasticity, humidity etc. It is, therefore, recommended to remeasure the sample flow rate when starting a SP-ICP-MS experiment or activity. Time-averaged measurements of, for example, 300 secs suffice.

When a dispersion of known number concentration is introduced to the ICP-MS instrument, the particle concentration observed may be lower than the actual concentration (for example, <10%). This is due to losses associated with the production of the aerosol and ion beam and its transport through the ion optics finally arriving at the mass spectrometer MS, which is instrument dependent.²¹

To account or correct for these losses, a dimensionless quantity can be introduced known as the transport efficiency (ηₜ) or the fraction of particles originally introduced that can actually be detected. Since the ηₜ is size dependent, sets of known particle size and concentration are introduced and their N determined (FIG. 3C). Calibration can then be performed using Eq. 2:

$${N}_{obs} = {η}_{t} {N}_{Theo}$$

in which N_{obs} is the observed number concentration and N_{Theo} the theoretical particle concentration. The slope of FIG. 3C can be used to provide values of ηₜ for other particle sizes via interpolation.

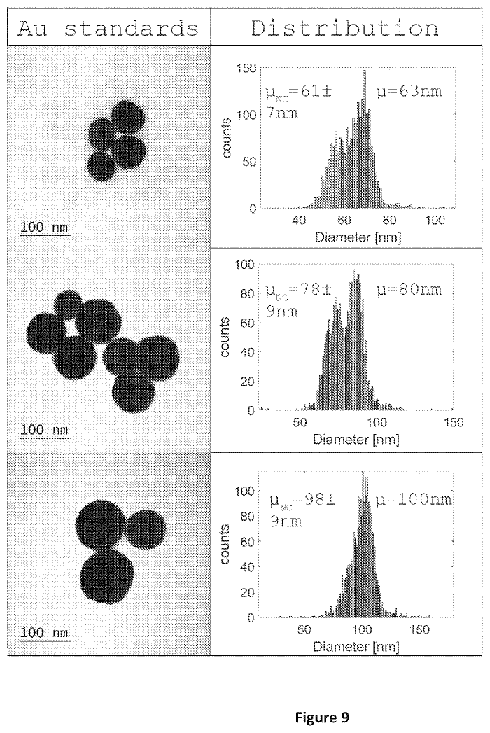

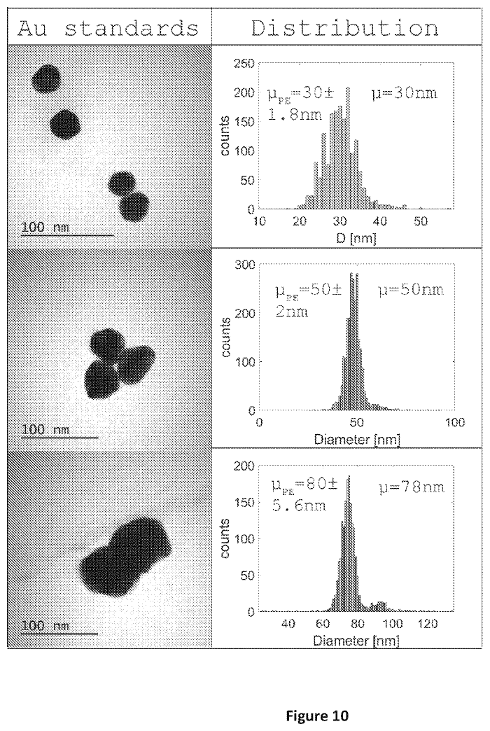

Often used calibrants are, for example, monodisperse isotropic Ag and Au nanoparticles, which can be purchased from various sources (see below and FIGS. 9 and 10). The inventors have used Au NPs as calibrants in the present work. Alternatively, for inductively-coupled plasma mass spectrometer equipped with a microdroplet generator, the transport efficiency (ηₜ) can directly be inferred from the droplet calibrants without the use of NP standards.²³

With the instrument calibrated and the transport efficiency ηₜ obtained, one could directly measure the number concentration of any sample dispersion.

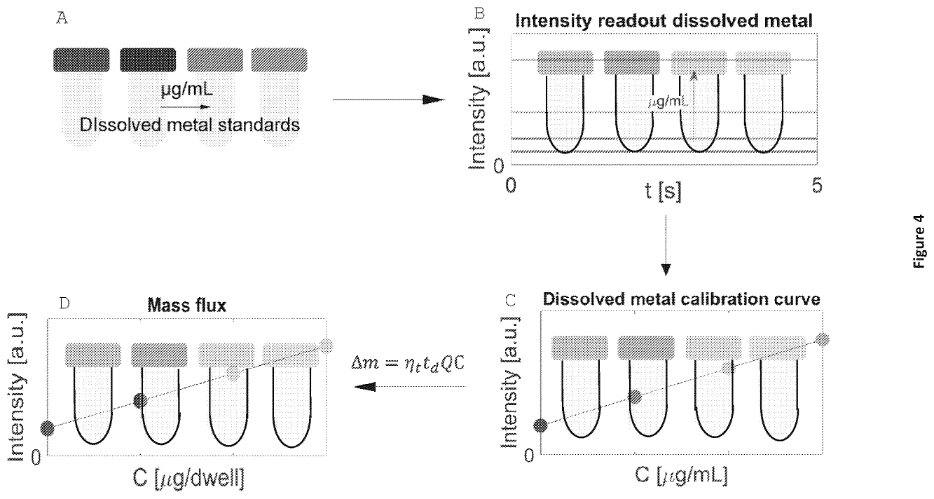

However, in order to determine the mass of the particles counted, another calibration is carried out. As mentioned before, in ICP-MS, the dissolved metal concentration of an unknown solution is determined by comparing the average intensity measured to the intensity of solutions of known concentrations. Similarly, in SP-ICP-MS, unknown particle mass is determined via a calibration curve based on dissolved standards (FIG. 4). In here, dissolved solutions, for example, dissolved metal solutions of known concentrations are prepared, introduced to the ICP-MS instrument and their respective average intensities obtained as a function of time (FIG. 4A-B). Plotting the average intensity versus the concentration of the dissolved standard reveals the linear relation between the ion intensity and dissolved concentration (FIG. 4C). Of course, in SP-ICP-MS, the intensities are not time averaged and instead measured at discrete intervals (or dwells). Therefore, the calibration curve (abscissa is μg/mL; FIG. 4C) is to be converted to the amount of material detected per dwell (μg/interval; FIG. 4D). This can be achieved according to Eq. 3:

$$Δ m = {η}_{t} {t}_{d} QC$$

in which ηₜ is the transport efficiency needed to correct for ion losses in the ion optics (dimensionless), t_{d} is the dwell time (or acquisition interval time, [μs]), Q the flow rate (mL/min) and C the dissolved ion concentration (μg/mL).

Mass flux calibration data or at least one mass flux calibration curve data relating a value of the intensity Iₚ measurement or data of the inductively-coupled plasma mass spectrometer to a mass of material detected per acquisition interval or dwell time is provided or received (S2) by the method of the present disclosure.

The slope a of the converted calibration curve then relates the intensity of the ion plume to the particle mass mₚ through Eq. 4:

$${m}_{p} = \frac{{I}_{p}}{{am}_{f} {η}_{i}}$$

in which ηᵢ is the ionization efficiency, the dimensionless parameters that allows for a correction factor for materials that ionize poorly.

Partial ionization is strongly mass dependent both relative and absolute, and has been determined for Au to occur for particles >150 nm.^{24,13} Further, partial ionization may also play a role for metal oxides for their generally high boiling points.^{24,13}

For the class of materials investigated in the present disclosure, however, this parameter ηᵢ equals to 1.

And m_{ƒ,} the mass fraction, is the contribution to the total particle mass of the element analyzed and is purely introduced for modelling purposes. For example, only metal species in metal oxide analytes' can be observed and with the parameter m_{ƒ} this can be corrected for (the multitude of possible oxygen sources other than the analyte make quantification with ICP-MS impossible). The mass fraction m_{ƒ} may thus also be equal to 1 and depends on the material being analyzed.

With the particle mass mₚ in hand (S3) (Eq. 4) using the mass flux calibration data or the at least one mass flux calibration curve data (S2), the counts per intensity histogram of the analyte can be converted into a size-distribution (S5).

In the first step, the particle mass mₚ is converted to a particle volume Vₚ (S4) using the density ρ as follows (Eq. 5):

$$\frac{{m}_{p}}{ρ} = {V}_{p}$$

The density ρ being a known density value or a presumed density value of the particle or analyte.

Then, depending on the specific geometry a particle ensemble consists of, for example spherical, cubic, truncated octahedral or tetrahedral geometry or shape, the volume Vₚ can be converted into a geometrical descriptor, such as the edge length (el). For particles of spherical shape, the edge length is given, for example, by Eq. 6 and is equivalent to the diameter:

$${el}_{Sph} = {( \frac{6 {V}_{p}}{π} )}^{1 / 3} .$$

For particles of cubic shape, the edge length or center-to-center distance of two adjacent corner atoms is, for example, simply the cube root of the volume Vₚ (Eq. 7):

$${el}_{Cu} = {( {V}_{p} )}^{1 / 3} .$$

For particles of cuboctahedral shape, the volume is given by a cube, which is truncated by eight equal tetrahedrons. For a regular cuboctahedron, the edge length is given, for example, by (Eq. 8):

$${el}_{CuOh} = {( \frac{3 {V}_{p}}{5 \sqrt{2}} )}^{1 / 3} .$$

For particles of octahedral shape, the volume is given by two joined pyramids. For a regular octahedron, the edge length is given, for example, by (Eq. 9):

$${el}_{Oh} = {( \frac{3 {V}_{p}}{\sqrt{2}} )}^{1 / 3} .$$

For particles of truncated octahedral shape, the volume is given by two joined pyramids (similar to the regular octahedron), which are truncated by six equal pyramids. For a regular truncated octahedron, the edge length is given, for example, by (Eq. 10):

$${el}_{TOh} = {( \frac{{V}_{p}}{8 \sqrt{2}} )}^{1 / 3} .$$

For particle of tetrahedral shape, the volume is, for example, obtained from four joined, equal-sided triangles with the edge length given, for example, by (Eq. 11):

$${el}_{Th} = {( 6 \sqrt{2} {V}_{p} )}^{1 / 3} .$$

Finally, for particles of rhombic dodecahedral shape, the volume is given by a cube joined with six equal pyramids. For a regular rhombic dodecahedron, the edge length is given, for example, by (Eq. 12):

$${el}_{RDh} = {( \frac{9 {V}_{p}}{16 \sqrt{3}} )}^{1 / 3} .$$

The geometrical descriptor, for example, the edge length (el) is determined on the basis of a presumed, measured or predetermined particle geometry or shape of the particle or analyte. The particle geometry or shape can, for example, be determined using electron microscopy.

A particle volume Vₚ of the detected particles is determined or calculated (S4) according to the present method using the determined particle mass mₚ.

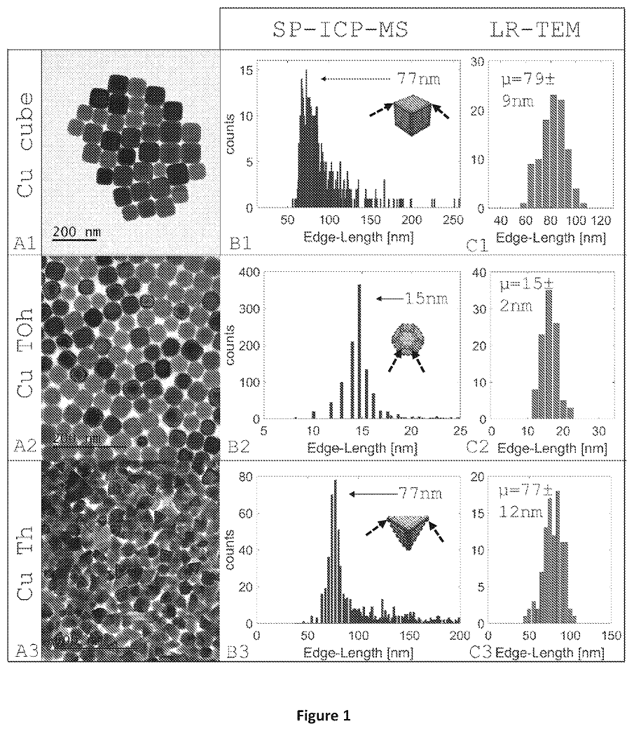

The determined geometrical descriptor, for example, the edge length (el) then allows to determine the particle size distribution (FIG. 3G, FIGS. 1, B1, B2, B3) using the determined particle volume Vₚ, providing a particle count as a function of the determined geometrical descriptor (for example, the edge length (el)). A particle size of the particles detected is thus determined or calculated (S5) using the determined particle volume Vₚ of the particles detected and the determined or attributed geometry or shape of the detected particles.

The particle size of the particles detected can thus be determined using a geometrical descriptor associated with the determined geometry or shape of the detected particles. The determined geometry or shape of the detected particles is, for example, a predetermined geometry or shape. The determined geometry or shape of the detected particles is predetermined using, for example, electron microscopy.

The geometrical descriptor comprises or consists of, for example, a particle edge-length el where the particle edge-length el is, for example, defined as a center-to-center distance between two adjacent corner atoms of a particle.

The particle size of the particles detected can be determined by determining a particle edge-length (el) of the particles detected using the determined particle volume Vₚ of the particles detected and the determined or attributed geometry or shape of the detected particles. As mentioned previously, the determined or attributed geometry or shape of the detected particles can be, for example, spherical, cubic, cube octahedral, octahedral, truncated octahedral, tetrahedral, or rhombic dodecahedral.

As mentioned previously, the particle volume Vₚ of the detected particles is determined using the determined particle mass mₚ and a density value ρ of the detected particles. The density value ρ of the detected particles is, for example, a predetermined density value ρ.

As indicated previously, the particle mass mₚ of the particles detected can, for example, be calculated using a slope value a determined from the mass flux calibration data or the at least one mass flux calibration curve data. The particle mass mₚ of the particles detected can be determined or calculated using the previously mentioned Equation 4,

$${m}_{p} = \frac{{I}_{p}}{{am}_{f} {η}_{i}}$$

wherein a is a slope value determined from the mass flux calibration data or the at least one mass flux calibration curve data, ηᵢ an ionization efficiency correction factor having a positive value between 0 and 1, and m_{ƒ} is a mass fraction factor having a positive value between 0 and 1.

Also, as indicated previously, the mass flux calibration data or the at least one mass flux calibration curve data can, for example, be determined by converting dissolved metal calibration data or at least one dissolved metal calibration curve relating a measured intensity to concentration using the equation:

$$Δ m = {η}_{t} {t}_{d} QC$$

in which ηₜ is a transport efficiency factor correcting for ion losses in the inductively-coupled plasma mass spectrometer, t_{d} is a dwell time or acquisition interval time, Q a sample flow rate of the inductively-coupled plasma mass spectrometer and C a dissolved ion concentration.

The detected particles comprise or consist of, for example, at least one or a plurality of inorganic elements. The constituent material of the detected particles may, for example, be predetermined or known. The density value ρ of the detected particles may, for example, be predetermined or known. The geometry or shape of the detected particles may, for example, be predetermined or known.

The particles to be sized and counted are, for example, nanoparticles.

An inductively-coupled plasma mass spectrometer configured to carry out single-particle inductively coupled plasma mass-spectrometry, or an inductively-coupled plasma mass spectrometer equipped with a microdroplet generator is, for example, provided and used as part of the method. The inductively-coupled plasma mass spectrometer can be, for example, a quadrupole, time-of-flight or a sector-field based instrument.

The method may additionally include determining or calculating a particle atomicity Aₚ or a number of atoms Aₚ in the particle of the detected particles using, for example, the determined particle mass mₚ. The particle atomicity Aₚ of the detected particles is determined using the determined particle mass mₚ and an atomic mass value of the detected particles. The atomic mass value of the detected particles is, for example, a predetermined atomic mass value.

Additionally, a particle composition distribution can, for example, be determined or calculated using the determined atomicity Aₚ of the detected particles. The particle composition distribution is used, for example, used to determine the particle structure such as core-shell, homogeneously mixed and or heterostructure.

According to a further aspect of the present disclosure, the method is, for example, a computer implemented method for single-particle inductively-coupled plasma mass spectrometry particle sizing and counting.

A further aspect of the present disclosure concerns a system or apparatus adapted or comprising means for carrying out the computer implemented method for single-particle inductively-coupled plasma mass spectrometry particle sizing and counting.

The system or apparatus includes, for example, at least one processor or calculation means; and at least one memory or storage means including a computer program comprising instructions which, when the computer program is executed by the processor or calculation means, cause the system or apparatus to carry out the method for single-particle inductively-coupled plasma mass spectrometry particle sizing and counting.

The system or apparatus includes, for example, further includes any one of the inductively-coupled plasma mass spectrometers mentioned in the present disclosure.

A further aspect of the present disclosure concerns a computer program comprising instructions which, when the program is executed, cause the computer or system to carry out the method for single-particle inductively-coupled plasma mass spectrometry particle sizing and counting.

Yet a further aspect of the present disclosure concerns a computer-readable data carrier having stored thereon, the computer program

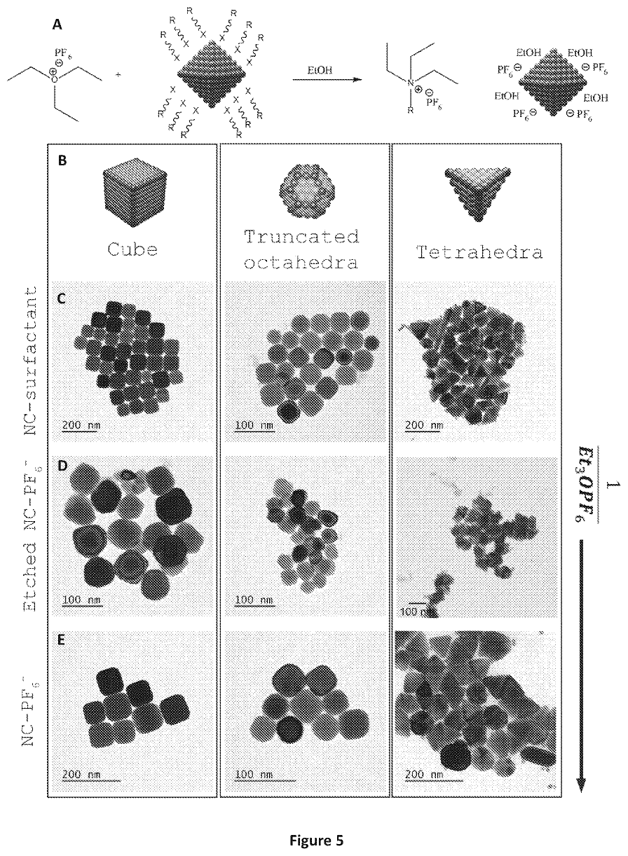

FIG. 5 shows an exemplary sample preparation and solvent transfer via surfactant stripping using triethyl oxonium hexafluorophosphate.

For colloidal nanoparticles and or nanocrystals that are dispersible in aqueous solutions,^{25,26,27} dilutions can be prepared directly from the stock dispersions. However, many colloidal nanocrystals and or nanoparticles are prepared in non-polar organic solvents.^{28,5,29,30,31} Therefore, solvent transfer can be performed in order to make the dispersions compatible with the aqueous environment of ICP-MS.^{32,33} Often, however, colloidal nanoparticles and nanocrystals are synthesized using surfactants that contain non-polar groups to obtain stable dispersions or facilitate shape-control.^{28,5,29,30,31} Due to the miscibility gap between the apolar features of common capping agents such as primary amines, fatty acids, phosphines, and aliphatic thiols and the polar medium, surfactant stripping must be performed prior to solvent transfer.³² Depending on the material considered i.e. metals, metal oxides and or semiconductors, various protocols have been developed.^{34,35,36,37} One facile and relatively gentile approach is to use Meerwein's reagent Et₃O⁺ to alkylate native surfactants, replacing them by an inorganic counter ion i.e. hexafluorophosphate and or solvent.³⁸ For easily oxidizable metals such as Cu (standard reduction potential: +0.3 V), a more soft electrophile is needed to prevent etching and retain the particles mass and shape.

Therefore, a sample or dilution preparation step according to the method of the present disclosure comprises, for example, using an alkylating agent or weak alkylating agent to carry out surfactant stripping on a plurality of particles to be sized and counted, to remove native surfactants and replace the native surfactants with at least one inorganic counter ion. Washing can be carried out after introduction of the alkylating agent or weak alkylating agent. The alkylating agent or weak alkylating agent may, for example, comprise or consist of a triethyl oxonium salt. The alkylating agent or weak alkylating agent may, for example, comprise or consist of triethyl oxonium hexafluorophosphate or triethyl oxonium tetrafluoroborate.

The plurality of particles has been, for example, prepared or synthesized in non-polar organic solvents.

A concentration of the alkylating agent or the weak alkylating agent is, for example, determined to carry out surfactant stripping without etching or minimally etching a surface of the particles.

The particles stabilized with an inorganic counter ion are, for example, dispersed in a polar solvent. An aqueous dispersion is, for example, prepared and provided to the inductively-coupled plasma mass spectrometer to carry out intensity Iₚ measurements representing particle detection as a function of time.

The inventors have used, for example, triethyl oxonium hexafluorophosphate, a relatively weak alkylating agent, to perform the surfactant stripping (FIG. 5A). By carefully adjusting the Et₃OPF₆ concentration, surfactant stripping can be achieved without damaging the nanocrystal surface (FIG. 5C: native surfactant capped and 5E: PF₆_{^{−}} capped nanocrystals). If the trialkyl oxonium salt concentration is too high, or if washing is not performed immediately after introduction of the alkylating agent, etching of the nanocrystal surface occurs, effectively shifting the obtained distribution to lower values (FIG. 5D). Contrarily, if too little of the Meerwein's salt is used, native surfactants remain at the particle surface resulting in the formation of aggregates after solvent transfer derailing the interpretation of the final distributions. Generally, for dispersions with a metal concentration of 1-20 mg/mL and a diameter between 20-200 nm, a solution of 13 mM Et₃OPF₆ in a 1:1 volumetric ratio suffices. A more detailed description of the surfactant stripping and solvent transfer is provided below.

Dilutions can now be prepared. With the nanocrystals and or nanoparticles stabilized with an inorganic counter ion, dispersing in polar solvents such as DMF, EtOH, MeOH and acetone, is now possible. It is pointed out that for easily oxidizable materials such as Cu, Zn, etc. usage of dry solvents is advised as ionization efficiencies may vary between the metals and their respective metal oxides, which could affect the measurement.¹⁴ The final aqueous dilutions can be prepared by introducing the required amount of the anhydrous polar dispersions directly to the water phase at the start of the measurement. Preferably, one aims for a nanoparticle concentration between 10,000 and 100,000 particles per mL as estimated based on TEM particle counting coupled with ICP-OES (optical emission spectroscopy) or ICP-MS. The reason to keep the concentration range narrow will come apparent below. Lastly, for the instability of certain metals in water, fresh dilutions are preferably prepared for each individual measurement.

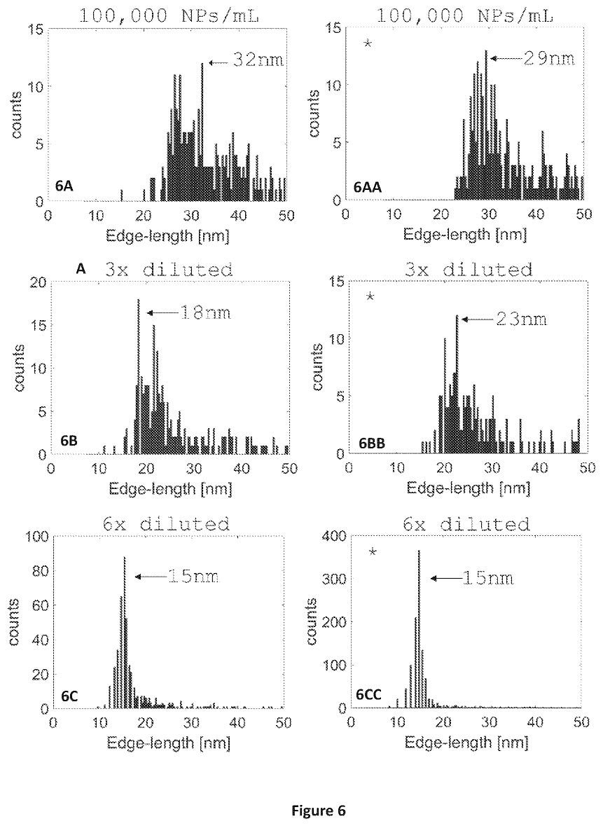

In order to have the most accurate measurement, it is adamant that each particle event can be distinguished from the next. If multiple particles or, rather, their ion plumes, arrive in the mass filter with too short a time interval to be resolved, their summed mass will be recorded instead and assigned by the algorithm to a single particle event. Therefore, when the concentration of particles in the sample dispersion is too high, the average size shift to higher values. Consider the size-distributions in FIG. 6. In here, dilutions of the 15 nm TOh NPs of 10⁵, ⅓·10⁵ and ⅙·10⁵ were prepared estimated from ICP-MS and TEM micrograph analysis. The measured most frequent size was: 32 nm (FIG. 6A, Table 2), 18 nm (FIG. 6B) and 15 nm (FIG. 6C), respectively. For the first and second dilution, an 8- and 4-fold larger mass was recorded in comparison to obtained via TEM and measured for the last dilution (FIG. 1, FIG. 6C). This shows the particle concentration cap. Beyond it; multiple particle events cannot be excluded. Diluting further, on other hand, will result in progressively lower numbers of counts as not all intervals will contain a particle event. Of course, this could be off-set by extending the measurement time but this is rather impractical: for every additional second measured, with t_{d}=50 μs, 2·10⁴ data points are added to the data file. Therefore, a sweet spot exists where the concentration yields good statistics with the least amount of data but excludes multiple particle events. For the Cu NPs reported and using the instrument settings as outlined further below, this lies between 10,000-20,000 NPs/mL. However, this value can vary strongly between particles of different elements and depends on both the chemical nature of the NP, its size and the instrument and instrument settings used (i.e. Au 30-100 nm ˜50,000 NPs/mL for t_{d}=50 μs).^{39,40} Preparing dilution series as in FIG. 6 can be of tremendous value to calibrate a measurement when sweet spot number concentrations are unknown. Note the difference in counts between FIGS. 6A/6B and 6C. When multiple particle events occur, ion signals that could be resolved, are not and as such low counts follow. Then, when the single particle per event condition is met, the total number of counts goes up by at least an order. This can be used as a handle to solve any particle concentration problem. Finally, multiple particle events can also be reduced by adjusting the pump speed. However, smaller flow rates will extend measurement times, which is a limiting factor.

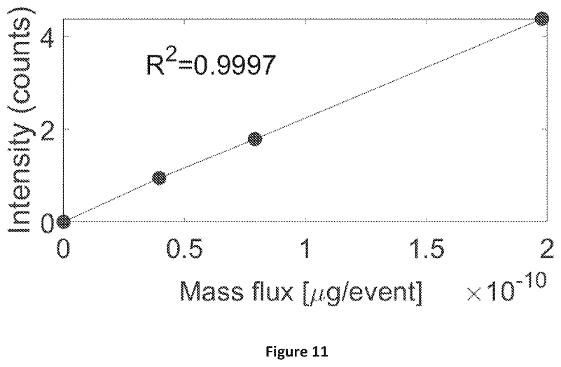

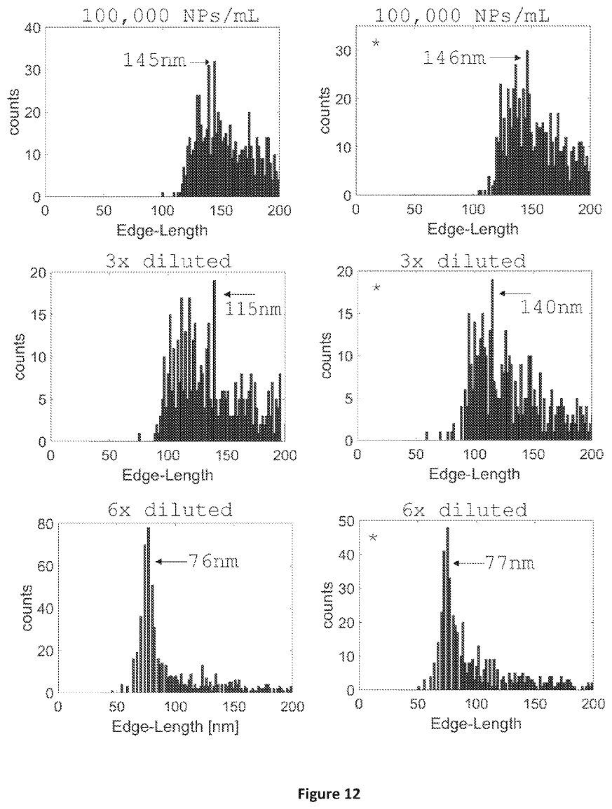

To determine the reliability of the technique to produce reproducible size-distributions (it still being one of the main means to show ensemble (in)homogeneity),^{5,6} the inventors prepared two dilution series of the same particle (TOh, FIGS. 6A-C and FIG. 6AA-CC) but used independent internal standards for the instrument calibration of ηₜ (FIGS. 9 and 10). By using the same mass/interval calibration curve for both dilution series (FIG. 11), the inventors ensured that any changes to the size distribution originated from inaccuracy in the determination of the ηₜ, which is expected to introduce the largest error.¹⁴ When the particle concentration hits the sweet spot, a perfect match in the particle mass is obtained with the edge-length of the TOh determined at 15 nm in both cases, independently of calibrant used (FIGS. 6C and 6CC). With a well-calibrated instrument, precise and accurate size-distributions can be obtained reproducibly. This is independent of particle size and shape (for particles above the limit of detection)⁴¹ as equally agreeing results could be obtained for the Th (FIGS. 11 and 12).

The inventors further investigated the accuracy and precision of SP-ICP-MS to determine number concentrations as they are of interest to study colloidal stability, nanoparticle sintering and catalytically active surface area estimation, amongst others.^{42,43,44} The inventors prepared 6 independent dilutions of Th, C and TOh, based on a four-fold dilution series, and measured the particle concentrations (Table 1). With an uncertainty of the measurement of only 3.7% (estimated through error propagation of the dilution series based on manufacturer reported uncertainties at 3.5%), SP-ICP-MS allows for number concentration determinations with high precision. Further, it reveals a consistently lower particle concentration (˜10%) than estimated based on TEM particle counting. This can both be explained through aggregates in the sample and poor statistics of TEM micrograph analysis (only a 100 counts). Finally, the inventors would like to stress using well-calibrated micropipettes when number concentrations are the sought-after quantity (Table 1). Poorly calibrated pipettes easily introduce measurement uncertainties >20% surpassing the error introduced by the meagre statistics and bias of particle counting.

TABLE 1
Theoretical (based on TEM micrograph analysis) and mean particle
concentration of 6 independent measurements obtained from
a dilution series using two sets of micropipettes: 1) certified
calibration and 2) uncalibrated. Coefficient of variation
(CV) = σ/μ = 0.037 and 0.26, respectively.

| | Measured particle conc. | Measured particle conc. |
|---|---|---|
| | Calibrated | Uncalibrated |
| Theoretical particle | micropipette | micropipette |
| conc. [NPs/mL] | [NPs/mL] | [NPs/mL] |
| 16,667 | 14,995 ± 556 | 15,027 ± 3964 |

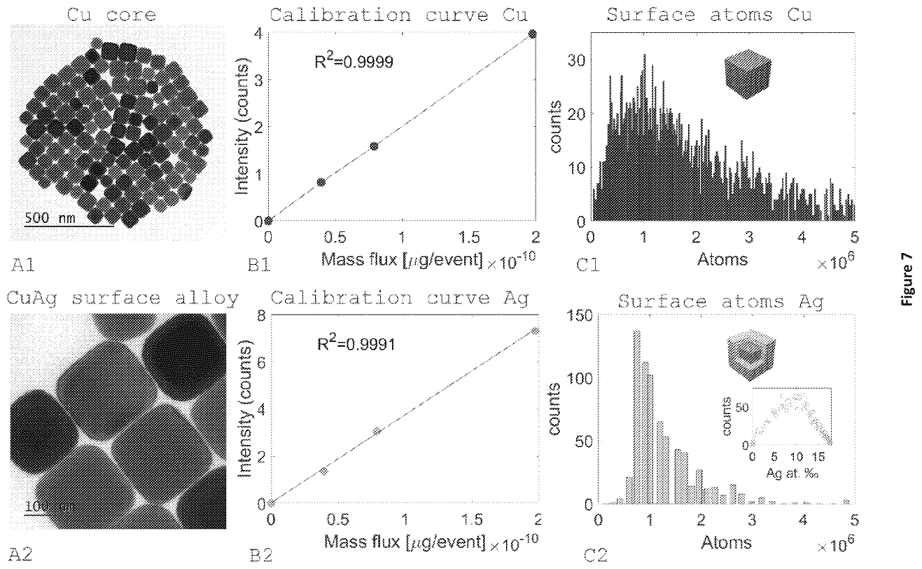

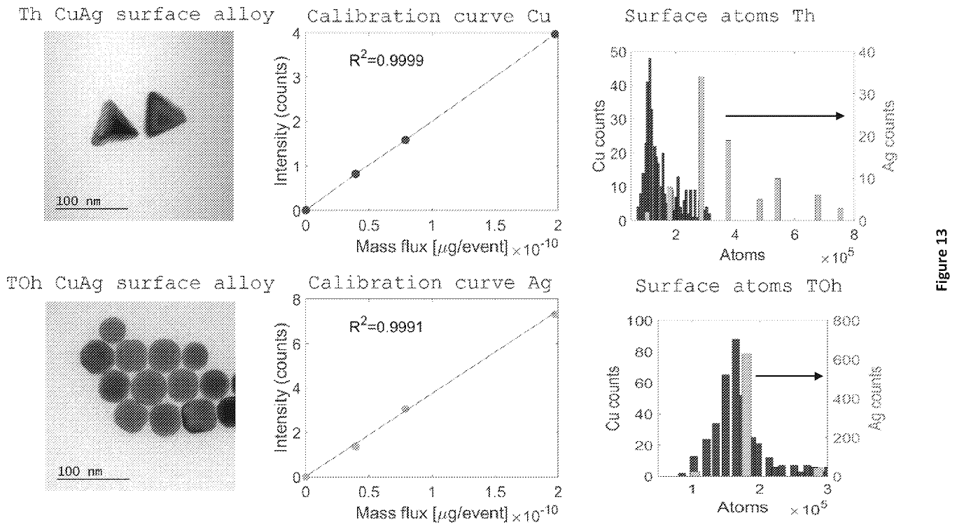

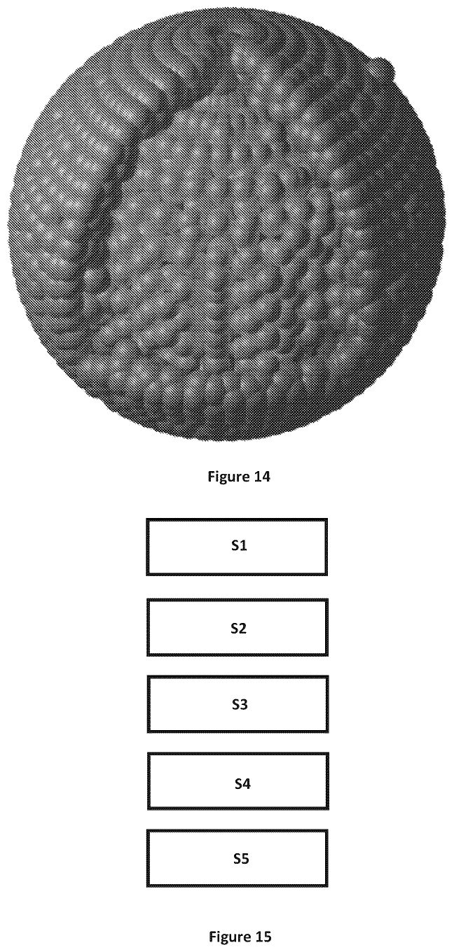

Another application of SP-ICP-MS is to quantify different elements within a particle ensemble.⁴⁵ Due to the short dwell times needed for SP-ICP-MS, time-of-flight mass analyzers are required to obtain a full elemental spectrum in a single sweep.^{46,47,48,13} The quadrupole used presently (see below), however, does allow for sequential spectral analysis.¹³ Using a galvanic exchange reaction, the inventors have synthesized anisotropic CuAg surface alloy's for electrocatalytic purposes,¹¹ which will be the subject of a later work (FIGS. 7A1, A2 and FIG. 13). Obtaining the ensemble Ag and Cu distribution with SP-ICP-MS (FIGS. 7B1, B2), followed by a subsequent subsurface based modelling step (FIG. 14), the inventors were able to determine the ensemble average surface composition of the anisotropic particles (FIGS. 7C1, C2). The inventors deduce that the ensemble average surface alloy contains 0.52 ML of Ag. Further, the inventors stress that this method allows to distinguish a core-shell particle from homogeneous mixtures as the correlation between the atoms of the outermost Cu layer and the total amount of Ag atoms can only exist if the Ag is at the surface. For a homogeneous mixture or any other heterostructure than core-shell, the total Ag content is independent of the surface.

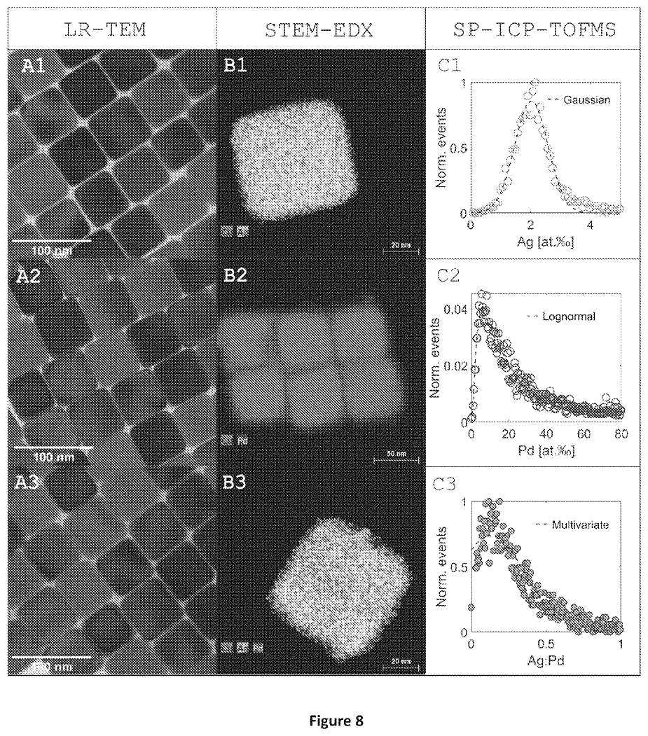

While sequential analysis suffices for simple bimetallic samples, experiment and data treatment quickly becomes tedious for more complex systems. Further, data treatment requires assumptions and preexisting knowledge of the sample, e.g., that each particle contains all elements. Therefore, the inventors extended upon their galvanic replacement reaction to produce next to C-CuAg NSAs, C-CuPd and C-CuPdAg anisotropic multimetallic NPs to show the capabilities of TOF mass analyzers to determine the elemental make-up of every single particle simultaneously and its advantage over quadrupole mass analyzers for, e.g., doping studies (FIG. 8). The inventors confirmed the normal distribution of Ag in the C-CuAg NSA (FIG. 8C1) and determined that in the case of CuPd, a positive skew ensured with an order larger Pd content (FIG. 8C2). The inventors could verify the presence of Ag and Pd in the respective bimetallic systems using scanning transmission electron microscopy energy dispersive X-ray spectroscopy (STEM-EDX), which showed a core-shell like morphology for C-CuPd NPs, corroborating the higher average Pd content determined with SP-ICP-TOFMS (FIG. 8B1-B2). Moreover, by reintroducing C-CuAg NSAs in the Pd-precursor reaction mixture, the inventors were able to synthesize C-CuPdAg NPs as well (FIG. 8A3-C3).

Additional experimental details are now provided.

### Chemicals

The following chemicals and solvents were acquired from Sigma-Aldrich: copper acetylacetonate 99.99% (Cu(acac)₂), palladium chloride 99% (PdCl₂), copper bromide 99.99 % (CuBr), nitric acid 70% (HNO₃), trioctylphosphine oxide 99% (TOPO), trioctylphsopshine 99% (TOP), oleyl amine 70% (OLAM), oleic acid 90% (OLAC), dichloromethane (DCM), dimethyl formamide. Anhydrous ethanol 95% was purchased from ACROS organics (EtOH) and anhydrous toluene (99.8%) and triethyl oxonium tetrafluoroborate 1.0 M in DCM from Alfa Asear. Lastly, silver nitrate 99.9995% was obtained from Puratrem (AgNO₃). All chemicals were used as received without any further purification. All solvents, were used as is, except for DCM, which was distilled at 40° C. in inert atmosphere to dry it. All aqueous solutions were prepared with di-ionized (DI) water with a resistivity of 18.2 MΩ·cm.

### Synthesis Anisotropic Copper Crystals

All three Cu nanocrystal morphologies were synthesized using a reflux set-up under inert conditions. For the Cu-C, 0.45904 g CuBr and 1.78 mL TOP stored in a glove box, were mixed with 9 mL of degassed OLAM and sonicated for 10 min to form a transparent, pale yellow solution. Meanwhile, 50 mL of OLAM (70%) was added to a 250 mL three-necked flask and degassed under vacuum. The flask was purged with N₂ after the bubble formation has stopped. Using a clean syringe, the reaction mixture was then quickly added to the flask. The mixture was heated to 80° C. using a heating mantle and kept at that temperature for 30 min, whilst applying low-vacuum, to dry the solution. The yellow transparent reaction mixture was purged with N₂ and the temperature quickly increased to 270° C. and kept for 1 hour. At 270° C., the reaction mixture turned red indicating nucleation. After the solution had cooled to rt, the reaction mixture was transferred to the glove box and washed with toluene using centrifugation (7,500 rpm for 5 min). The Cu-C pellet was redispersed in 5 mL of toluene. For Cu-TOh, the reaction was carried out at 260° C. instead, all other conditions were kept the same. For the Cu-Th, 0.23908 g CuBr and 3.12417 g dry TOPO were dissolved in 5 mL degassed OLAM using ultrasonication (10 min), yielding a pale, yellow translucent solution. This was then quickly added to 34 mL OLAM in a three-necked flask under inert atmosphere using a syringe. Then, the temperature was raised to 80° C. under vacuum, kept for 30 min, and raised further to 180° C., inducing a boil. The pale, yellow solution turned a deep gold. At this point, a N₂ purge was applied and the temperature further raised to 260° C. upon which the solution turned translucent black indicating nucleation. The reaction was continued for 1 h yielding a purple dispersion, which was likewise washed using toluene.

### Silver, Palladium Coating: Surface Alloy

4 mg of NPs dispersed in toluene were added to a 10 mL glass vial to which 3.5 mL of degassed OLAM were carefully added, without disturbing the NP film. Additionally, 0.5 mg of dry AgNO₃ or PdCl₂ were added to 1.5 mL of degassed OLAM and heated at 50 or 80° C. using an oil bath until dissolved. AgNO₃ or PdCl₂ in OLAM was then carefully added to the reaction vial, which was then allowed to react at 80° C. for 60 s with C-Cu and TOh-Cu, or 50° C. for 300 s with Th-Cu, after which the reaction was quenched with toluene. This yielded the Th- and TOh-CuAg and C-CuAg/Pd. For the synthesis of C-CuPdAg, 4 mg of C-CuAg rather than C-Cu NPs were used instead. All other parameters were kept the same. The coated crystals were washed with toluene and stored in a glovebox.

### Aqueous Dispersion Preparation

100 μL of the (bi)metallic (an)isotropic nanoparticle dispersions in the concentration range of 2-20 mg/mL were added to 100 μL of a 13 mM Et₃OPF₆ in DCM and sonicated. The samples were then washed with DMF (1 mL, 5000 rpm and 2 min) in three-fold and dispersed in 100 μL DMF. An aliquot equivalent of 100,000 NPs/mL over a 3-step dilution series was added to deionized water, which was used for sampling.

### Characterization

Electron microscopy. Transmission electron microscopy (TEM) images and selected-area electron diffraction (SAED) patterns were acquired with a FEI Tecnai Basic Spirit operated at 120 kV in bright field mode. The microscope was equipped with a Gatan charge-coupled device (CCD) camera and Digital Micrograph for imaging. Samples were drop-casted on 400 mesh carbon film copper grids from Ted Pella Inc., which were washed with ethanol before and after drop-casting. Size distributions were obtained through edge-length analysis using the FIJI ImageJ software package of at least 100 unique particles.

Inductively-coupled plasma—optical emission spectroscopy (ICP-OES). The concentration of the NP solution was determined with an Agilent 5110 ICP-OES with a VistaChip II CCD camera. The NPs were digested overnight in 2% HNO₃ and filtered with 400 μm pore size Ultrapore filters. The calibration curves were obtained through the preparation of a dilution series of elemental standards obtained from Sigma Aldrich.

Inductively-coupled plasma mass spectrometry (ICP-MS). Particle sizing and counting was achieved with a NexION 350D ICP-MS instrument from PerkinElmer operated in continuous data acquisition mode. A RF power of 1600 W was used to generate the plasma, with the auxiliary gas and nebulizer gas flow kept at 1.2 mL min⁻¹ and 1.12 mL min⁻¹, respectively. The frequency of rotation of the pump was kept at 40 rpm. The flow rate changed from day to day ranging from 0.6 to 0.8 mL/min. The dwell time was kept at 50 μs for all measurements. Spectra obtained for 100 s in all cases. Calibration of the transport efficiency (ηₜ) was achieved with standard Au NPs of 61, 78 and 98 nm purchased from NanoComposix and 30, 50 and 80 nm purchased from PerkinElmer at number concentration of ˜50,000 NPs/mL (FIGS. 9 and 10). After Au NPs standard introduction, the instrument was rinsed with 2% HCl for 30 s and 2% HNO₃ after Cu(Ag) NP sampling. Before introduction of a sample, equipment was rinsed with DI water. Dissolved metal calibration curves were obtained from elemental standards purchased from Sigma Aldrich.

TABLE 2
TOh dilution series sample parameters.

| | | Most | | Diss. | | |
|---|---|---|---|---|---|---|
| Toh | NP/mL | frequent | Mean | Conc. | TE (%) | Rsquared |
| Stock | 100000 | 23 | 42 | 3.13 | 3.46 | 0.999719148 |
| 3x | 33333.33333 | 18 | 31 | 0.94 | 3.46 | 0.999719148 |
| 6x | 16666.66667 | 15 | 19 | 0.35 | 3.46 | 0.999719148 |
| | | Most | | Diss. | | |
| Toh_2 | NP/mL | frequent | mean | Conc. | TE (%) | Rsquared |
| Stock | 100000 | 29 | 42 | 3.1 | 4.11 | 0.999719148 |
| 3x | 33333.33333 | 23 | 32 | 0.9 | 4.11 | 0.999719148 |
| 6x | 16666.66667 | 15 | 16 | 0.31 | 4.11 | 0.999719148 |

### Geometrical Model: Cube, Tetrahedra, Truncated Octahedra

### Geometrical Model of the Cube

The inventors first defined the particles mass, which for a cube is given by:

$${m}_{cube} = ρ \cdot {l}_{edge - legth}^{3}$$

With ρ the density of the bulk and l_{edge-length} the particle edge-length. With this, one can calculate the total number of atoms based on the volume and the volume of the unit cell:

$${Atoms}_{volume} = \frac{{l}_{edge - legth}^{3} \cdot {n}_{atoms}}{{l}_{unit cell}^{3}}$$

With nₐₜₒₘₛ the number of atoms in the unit cell and l_{unit cell} the lattice constant (FCC).

To determine the number of surface atoms, the inventors first defined a subsurface, which comprises the V_{cube} but with one monolayer of atoms subtracted (see FIG. 14 for a spherical representative schematic):

$${V}_{subsurface} = {( {l}_{edge - legth} - 4 {r}_{covalent} )}^{3}$$

in which r_{covalent} is the metal-metal bond length. In here the constraint is applied that l_{edge-legth}−4r_{covalent}>0 and that only a complete monolayer can be removed at a time. The number of surface atoms then becomes:

$${Atoms}_{surface} = \frac{( {V}_{Cube} - {V}_{subsurface} ) \cdot {n}_{atoms}}{{l}_{unit cell}^{3}}$$

$$With$$

$${Atoms}_{bulk} = {Atoms}_{volume} - {Atoms}_{surface} = {Atoms}_{subsurface}$$

### Geometrical Model of the Tetrahedra

The geometrical model of the Tetrahedra was derived following the same logic as for the cube. Therefore, we will only list the changes respective of the geometry.

$${Atoms}_{volume} = \frac{6 \sqrt{2} \cdot {l}_{edge - legth}^{3} \cdot {n}_{atoms}}{3 \cdot {l}_{unit cell}^{3}}$$

$$and$$

$${Atoms}_{subsurface} = \frac{6 \sqrt{2} {( {l}_{edge - legth} - 6 {r}_{covalent} )}^{3} \cdot {n}_{atoms}}{3 \cdot {l}_{unit cell}^{3}}$$

### Geometrical Model of the Truncated Octahedra

The geometrical model of the truncated octahedra was derived following the same logic as for the cube. We will, therefore, only list the changes respective of the geometry.

$${Atoms}_{volume} = \frac{8 \sqrt{2} \cdot {l}_{edge - legth}^{3} \cdot {n}_{atoms}}{{l}_{unit cell}^{3}}$$

$$and$$

$${Atoms}_{subsurface} = \frac{8 \sqrt{2} {( {l}_{edge - legth} - 2 {r}_{covalent} )}^{3} \cdot {n}_{atoms}}{{l}_{unit cell}^{3}}$$

Implementations described herein are not intended to limit the scope of the present disclosure but are just provided to illustrate possible realizations.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

### References

(1) Jones, M. R.; Osberg, K. D.; Macfarlane, R. J.; Langille, M. R.; Mirkin, C. A. Templated Techniques for the Synthesis and Assembly of Plasmonic Nanostructures. Chem. Rev. 2011, 111 (6), 3736-3827. https://doi.org/10.1021/cr1004452.
(2) Xia, Y.; Xiong, Y.; Lim, B.; Skrabalak, S. E. Shape-Controlled Synthesis of Metal Nanocrystals: Simple Chemistry Meets Complex Physics? Angew. Chem. Int. Ed. 2009, 48 (1), 60-103. https://doi.org/10.1002/anie.200802248.
(3) Liu, L.; Corma, A. Metal Catalysts for Heterogeneous Catalysis: From Single Atoms to Nanoclusters and Nanoparticles. Chem. Rev. 2018, 118 (10), 4981-5079. https://doi.org/10.1021/acs.chemrev.7b00776.
(4) Kleijn, S. E. F.; Lai, S. C. S.; Koper, M. T. M.; Unwin, P. R. Electrochemistry of Nanoparticles. Angew. Chem. Int. Ed. 2014, 53 (14), 3558-3586. https://doi.org/10.1002/anie.201306828.
(5) Chen, C.; Kang, Y.; Huo, Z.; Zhu, Z.; Huang, W.; Xin, H. L.; Snyder, J. D.; Li, D.; Herron, J. A.; Mavrikakis, M.; Chi, M.; More, K. L.; Li, Y.; Markovic, N. M.; Somorjai, G. A.; Yang, P.; Stamenkovic, V. R. Highly Crystalline Multimetallic Nanoframes with Three-Dimensional Electrocatalytic Surfaces. Science 2014, 343 (6177), 1339-1343. https://doi.org/10.1126/science. 1249061.
(6) Choukroun, D.; Pacquets, L.; Li, C.; Hoekx, S.; Arnouts, S.; Baert, K.; Hauffman, T.; Bals, S.; Breugelmans, T. Mapping Composition-Selectivity Relationships of Supported Sub-10 Nm Cu-Ag Nanocrystals for High-Rate CO2 Electroreduction. ACS Nano 2021. https://doi.org/10.1021/acsnano. 1c04943.
(7) Particle Analysis. ImageJ Wiki. https://imagej.github.io/imaging/particle-analysis (accessed 2021-09-21).
(8) Mondini, S.; Ferretti, A. M.; Puglisi, A.; Ponti, A. PEBBLES and PEBBLEJUGGLER: Software for Accurate, Unbiased, and Fast Measurement and Analysis of Nanoparticle Morphology from Transmission Electron Microscopy (TEM) Micrographs. Nanoscale 2012, 4 (17), 5356-5372. https://doi.org/10.1039/C2NR31276J.
(9) Laramy, C. R.; Brown, K. A.; O'Brien, M. N.; Mirkin, Chad. A. High-Throughput, Algorithmic Determination of Nanoparticle Structure from Electron Microscopy Images. ACS Nano 2015, 9 (12), 12488-12495. https://doi.org/10.1021/acsnano.5b05968.
(10) Lee, B.; Yoon, S.; Lee, J. W.; Kim, Y.; Chang, J.; Yun, J.; Ro, J. C.; Lee, J.-S.; Lee, J. H. Statistical Characterization of the Morphologies of Nanoparticles through Machine Learning Based Electron Microscopy Image Analysis. ACS Nano 2020, 14 (12), 17125-17133. https://doi.org/10.1021/acsnano.0c06809.
(11) Many-Particle Spectroscopy of Atoms, Molecules, Clusters, and Surfaces; Berakdar, J., Kirschner, J., Eds.; Springer US, 2001. https://doi.org/10.1007/978-1-4615-1311-7.
(12) Front Matter. In Inductively Coupled Plasma Mass Spectrometry Handbook; John Wiley & Sons, Ltd, 2005; pp i-xv. https://doi.org/10.1002/9781444305463.fmatter.
(13) Mozhayeva, D.; Engelhard, C. A Critical Review of Single Particle Inductively Coupled Plasma Mass Spectrometry—A Step towards an Ideal Method for Nanomaterial Characterization. J. Anal. At. Spectrom. 2020, 35 (9), 1740-1783. https://doi.org/10.1039/C9JA00206E.
(14) Pace, H. E.; Rogers, N. J.; Jarolimek, C.; Coleman, V. A.; Higgins, C. P.; Ranville, J. F. Determining Transport Efficiency for the Purpose of Counting and Sizing Nanoparticles via Single Particle Inductively Coupled Plasma Mass Spectrometry. Anal. Chem. 2011, 83 (24), 9361-9369. https://doi.org/10.1021/ac201952t.
(15) Pace, H. E.; Rogers, N. J.; Jarolimek, C.; Coleman, V. A.; Higgins, C. P.; Ranville, J. F. Correction to Determining Transport Efficiency for the Purpose of Counting and Sizing Nanoparticles via Single Particle Inductively Coupled Plasma Mass Spectrometry. Anal. Chem. 2012, 84 (10), 4633-4633. https://doi.org/10.1021/ac300942m.
(16) Liu, J.; Murphy, K. E.; MacCuspie, R. I.; Winchester, M. R. Capabilities of Single Particle Inductively Coupled Plasma Mass Spectrometry for the Size Measurement of Nanoparticles: A Case Study on Gold Nanoparticles. Anal. Chem. 2014, 86 (7). 3405-3414. https://doi.org/10.1021/ac403775a.
(17) Hadioui, M.; Knapp, G.; Azimzada, A.; Jreije, I.; Frechette-Viens, L.; Wilkinson, K. J. Lowering the Size Detection Limits of Ag and TiO2 Nanoparticles by Single Particle ICP-MS. Anal. Chem. 2019, 91 (20), 13275-13284. https://doi.org/10.1021/acs.analchem.9b04007.
(18) Hendriks, L.; Gundlach-Graham, A.; Günther, D. Analysis of Inorganic Nanoparticles by Single-Particle Inductively Coupled Plasma Time-of-Flight Mass Spectrometry. Chim. Int. J. Chem. 2018, 72 (4), 221-226. https://doi.org/10.2533/chimia.2018.221.
(19) Folens, K.; Van Acker, T.; Bolea-Fernandez, E.; Cornelis, G.; Vanhaecke, F.; Du Laing, G.; Rauch, S. Identification of Platinum Nanoparticles in Road Dust Leachate by Single Particle Inductively Coupled Plasma-Mass Spectrometry. Sci. Total Environ. 2018, 615, 849-856. https://doi.org/10.1016/j.scitotenv.2017.09.285.
(20) Thomas, R. Practical Guide to ICP-MS, 3rd edition.; CRC Press: Boca Raton, 2013.
(21) Degueldre, C.; Favarger, P.-Y.; Wold, S. Gold Colloid Analysis by Inductively Coupled Plasma-Mass Spectrometry in a Single Particle Mode. Anal. Chim. Acta 2006, 555 (2), 263-268. https://doi.org/10.1016/j.aca.2005.09.021.
(22) Degueldre, C.; Favarger, P.-Y.; Rossé, R.; Wold, S. Uranium Colloid Analysis by Single Particle Inductively Coupled Plasma-Mass Spectrometry. Talanta 2006, 68 (3), 623-628. https://doi.org/10.1016/j.talanta.2005.05.006.

(23) Ramkorun-Schmidt, B.; Pergantis, S. A.; Esteban-Fernández, D.; Jakubowski, N.; Günther, D. Investigation of a Combined Microdroplet Generator and Pneumatic Nebulization System for Quantitative Determination of Metal-Containing Nanoparticles Using ICPMS. Anal. Chem.2015, 87 (17), 8687-8694. https://doi.org/10.1021/acs.analchem.5b01604.
(24) Ho, K.-S.; Lui, K.-O.; Lee, K.-H.; Chan, W.-T. Considerations of Particle Vaporization and Analyte Diffusion in Single-Particle Inductively Coupled Plasma-Mass Spectrometry. Spectrochim. Acta Part B At. Spectrosc. 2013, 89, 30-39. https://doi.org/10.1016/j.sab.2013.08.012.
(25) Skrabalak, S. E.; Au, L.; Li, X.; Xia, Y. Facile Synthesis of Ag Nanocubes and Au Nanocages. Nat. Protoc. 2007, 2 (9), 2182-2190. https://doi.org/10.1038/nprot.2007.326.
(26) Lim, B.; Jiang, M.; Camargo, P. H. C.; Cho, E. C.; Tao, J.; Lu, X.; Zhu, Y.; Xia, Y. Pd-Pt Bimetallic Nanodendrites with High Activity for Oxygen Reduction. Science 2009, 324 (5932), 1302-1305. https://doi.org/10.1126/science.1170377.
(27) He, R.; Wang, Y.-C.; Wang, X.; Wang, Z.; Liu, G.; Zhou, W.; Wen, L.; Li, Q.; Wang, X.; Chen, X.; Zeng, J.; Hou, J. G. Facile Synthesis of Pentacle Gold-Copper Alloy Nanocrystals and Their Plasmonic and Catalytic Properties.Nat. Commun. 2014, 5 (1), 1-10. https://doi.org/10.1038/ncomms5327.
(28) Murray, C. B.; Norris, D. J.; Bawendi, M. G. Synthesis and Characterization of Nearly Monodisperse CdE (E=Sulfur, Selenium, Tellurium) Semiconductor Nanocrystallites. J. Am. Chem. Soc. 1993, 115 (19), 8706-8715. https://doi.org/10.1021/ja00072a025.
(29) Protesescu, L.; Yakunin, S.; Bodnarchuk, M. I.; Krieg, F.; Caputo, R.; Hendon, C. H.; Yang, R. X.; Walsh, A.; Kovalenko, M. V. Nanocrystals of Cesium Lead Halide Perovskites (CsPbX3, X=Cl, Br, and I): Novel Optoelectronic Materials Showing Bright Emission with Wide Color Gamut. Nano Lett. 2015, 15 (6), 3692-3696. https://doi.org/10.1021/n15048779.
(30) Bernal, M.; Bagger, A.; Scholten, F.; Sinev, I.; Bergmann, A.; Ahmadi, M.; Rossmeisl, J.; Cuenya, B. R. CO2 Electroreduction on Copper-Cobalt Nanoparticles: Size and Composition Effect. Nano Energy 2018, 53, 27-36. https://doi.org/10.1016/j.nanoen.2018.08.027.
(31) Tao, A. R.; Habas, S.; Yang, P. Shape Control of Colloidal Metal Nanocrystals. Small 2008, 4 (3), 310-325. https://doi.org/10.1002/smll.200701295.
(32) Jackson, W. M.; Drury, J. S. Miscibility of Organic Solvent Pairs. Ind. Eng. Chem. 1959, 51 (12), 1491-1493. https://doi.org/10.1021/ie50600a039.
(33) Boorn, A. W.; Browner, R. F. Effects of Organic Solvents in Inductively Coupled Plasma Atomic Emission Spectrometry. Anal. Chem. 1982, 54 (8), 1402-1410. https://doi.org/10.1021/ac00245a033.
(34) Rucareanu, S.; Maccarini, M.; Shepherd, J. L.; Lennox, R. B. Polymer-Capped Gold Nanoparticles by Ligand-Exchange Reactions. J. Mater. Chem. 2008, 18 (47), 5830-5834. https://doi.org/10.1039/B806375C.
(35) Dong, A.; Ye, X.; Chen, J.; Kang, Y.; Gordon, T.; Kikkawa, J. M.; Murray, C. B. A Generalized Ligand-Exchange Strategy Enabling Sequential Surface Functionalization of Colloidal Nanocrystals. J. Am. Chem. Soc. 2011, 133 (4), 998-1006. https://doi.org/10.1021/ja108948z.
(36) Nag, A.; Kovalenko, M. V.; Lee, J.-S.; Liu, W.; Spokoyny, B.; Talapin, D. V. Metal-Free Inorganic Ligands for Colloidal Nanocrystals; S2—, HS—, Se2—, HSe—, Te2—, HTe—, TeS32—, OH—, and NH2- as Surface Ligands. J. Am. Chem. Soc. 2011, 133 (27), 10612-10620. https://doi.org/10.1021/ja2029415.
(37) Meerwein, H.; Hinz, G.; Hofmann, P.; Kroning, E.; Pfeil, E. Über Tertiäre Oxoniumsalze, I.J. Für Prakt. Chem. 1937, 147 (10-12), 257-285. https;//doi.org/10.1002/prac. 19371471001.
(38) Rosen, E. L.; Buonsanti, R.; Llordes, A.; Sawvel, A. M.; Milliron, D. J.; Helms, B. A. Exceptionally Mild Reactive Stripping of Native Ligands from Nanocrystal Surfaces by Using Meerwein's Salt. Angew. Chem. Int. Ed. 2012, 51 (3), 684-689. https://doi.org/10.1002/anic.201105996.
(39) Shaw, P.; Donard, A. Nano-Particle Analysis Using Dwell Times between 10 Ms and 70 Ms with an Upper Counting Limit of Greater than 3×10 7 Cps and a Gold Nanoparticle Detection Limit of Less than 10 Nm Diameter. J. Anal. At. Spectrom. 2016, 31 (6), 1234-1242. https://doi.org/10.1039/C6JA00047A.
(40) Strenge, I.; Engelhard, C. Single Particle Inductively Coupled Plasma Mass Spectrometry: Investigating Nonlinear Response Observed in Pulse Counting Mode and Extending the Linear Dynamic Range by Compensating for Dead Time Related Count Losses on a Microsecond Timescale. J. Anal. At. Spectrom. 2020, 35 (1), 84-99. https://doi.org/10.1039/C9JA00327D.
(41) Lee, S.; Bi, X.; Reed, R. B.; Ranville, J. F.; Herckes, P.; Westerhoff, P. Nanoparticle Size Detection Limits by Single Particle ICP-MS for 40 Elements. Environ. Sci. Technol. 2014, 48 (17), 10291-10300. https://doi.org/10.1021/es502422v.
(42) Reske, R.; Mistry, H.; Behafarid, F.; Roldan Cuenya, B.; Strasser, P. Particle Size Effects in the Catalytic Electroreduction of CO2 on Cu Nanoparticles. J. Am. Chem. Soc. 2014, 136 (19), 6978-6986. https://doi.org/10.1021/ja500328k.
(43) Hou, Y.; Kovács, N.; Xu, H.; Sun, C.; Erni, R.; Gálvez-Vázquez, M. de J.; Rieder, A.; Hu, H.; Kong, Y.; Liu, M.; Wiley, B. J.; Vesztergom, S.; Broekmann, P. Limitations of Identical Location SEM as a Method of Degradation Studies on Surfactant Capped Nanoparticle Electrocatalysts. J. Catal. 2021, 394, 58-66. https://doi.org/10.1016/j.jcat.2020.12.006.
(44) Holišová, V.; Urban, M.; Konvičková, Z.; Kolenčík, M.; Mančík, P.; Slabotinský, J.; Kratošová, G.; Plachá, D. Colloidal Stability of Phytosynthesised Gold Nanoparticles and Their Catalytic Effects for Nerve Agent Degradation. Sci. Rep. 2021, 11 (1), 4071. https://doi.org/10.1038/s41598-021-83460-1.
(45) Merrifield, R. C.; Stephan, C.; Lead, J. R. Single-Particle Inductively Coupled Plasma Mass Spectroscopy Analysis of Size and Number Concentration in Mixtures of Monometallic and Bimetallic (Core-Shell) Nanoparticles. Talanta 2017, 162, 130-134. https://doi.org/10.1016/j.talanta.2016.09.070.
(46) Borovinskaya, O.; Hattendorf, B.; Tanner, M.; Gschwind, S.; Günther, D. A Prototype of a New Inductively Coupled Plasma Time-of-Flight Mass Spectrometer Providing Temporally Resolved. Multi-Element Detection of Short Signals Generated by Single Particles and Droplets. J. Anal. At. Spectrom. 2013, 28 (2), 226-233. https://doi.org/10.1039/C2JA30227F.
(47) Praetorius, A.; Gundlach-Graham, A.; Goldberg, E.; Fabienke, W.; Navratilova, J.; Gondikas, A.; Kaegi, R.; Günther, D.; Hofmann, T.; Kammer, F. von der. Single-Particle Multi-Element Fingerprinting (SpMEF) Using Inductively-Coupled Plasma Time-of-Flight Mass Spectrometry (ICP-TOFMS) to Identify Engineered Nanoparticles against the Elevated Natural Background in Soils. Environ. Sci. Nano 2017, 4 (2), 307-314. https://doi.org/10.1039/C6EN00455E.
(48) Naasz, S.; Weigel, S.; Borovinskaya, O.; Serva, A.; Cascio, C.; Undas, A. K.; Simeone, F. C.; Marvin, H. J. P.; Peters, R. J. B. Multi-Element Analysis of Single Nanoparticles by ICP-MS Using Quadrupole and Time-of-Flight Technologies. J. Anal. At. Spectrom. 2018, 33 (5), 835-845. https://doi.org/10.1039/C7JA00399D.

The entire content of each one of these references being incorporated herein by reference.

1-47. (canceled)

48. A Single-particle inductively-coupled plasma mass spectrometry particle sizing and counting method, the method comprising the steps of:
providing or receiving an intensity-versus-counts histogram of particles detected using an inductively-coupled plasma mass spectrometer, the intensity representing particle detection and the count representing particle detection frequency,
providing or receiving mass flux calibration data or at least one mass flux calibration curve data relating a value of the intensity measurement or data of the inductively-coupled plasma mass spectrometer to a mass of material detected per acquisition interval or dwell time,
determining a particle mass of the particles detected using the mass flux calibration data or the at least one mass flux calibration curve data,
determining a particle volume of the detected particles using the determined particle mass, and
determining a particle size of the particles detected using the determined particle volume of the particles detected and a determined or attributed geometry or shape of the detected particles.

49. The method according to claim 48, wherein the inductively-coupled plasma mass spectrometer is a quadrupole, time-of-flight or a sector-field based instrument.

50. The method according to claim 48, further including determining a particle atomicity or number of atoms in the particle of the detected particles using the determined particle mass.

51. The method according to claim 48, wherein the determined geometry or shape of the detected particles is predetermined using electron microscopy.

52. The method according to claim 48, wherein the particle size of the particles detected is determined using a geometrical descriptor associated with the determined geometry or shape of the detected particles.

53. The method according to claim 52, wherein the geometrical descriptor comprises or consists of a particle edge-length.

54. The method according to claim 53, wherein the particle edge-length is defined as a center-to-center distance between two adjacent corner atoms of a particle.

55. The method according to claim 54, wherein the particle size of the particles detected is determined by determining a particle edge-length of the particles detected using the determined particle volume of the particles detected and the determined or attributed geometry or shape of the detected particles.

56. The method according to claim 48, wherein the determined or attributed geometry or shape of the detected particles is spherical, cubic, cube octahedral, octahedral, truncated octahedral, tetrahedral, or rhombic dodecahedral.

57. The method according to claim 50, wherein the particle atomicity of the detected particles is determined using the determined particle mass and the atomic mass value of the detected particles.

58. The method according to claim 50, wherein a particle composition distribution is determined using the atomicity of the detected particles.

59. The method according to claim 58, wherein the particle composition distribution is used to determine the particle structure such as core-shell, homogeneously mixed and or heterostructure.

60. The method according to claim 48, wherein the particle mass of the particles detected is calculated using a slope value determined from the mass flux calibration data or the at least one mass flux calibration curve data.

61. The method according to claim 48, wherein the particle mass of the particles detected is calculated using the following equation:
$${m}_{p} = \frac{{I}_{p}}{{am}_{f} {η}_{i}}$$
wherein a is a slope value determined from the mass flux calibration data or the at least one mass flux calibration curve data, ηᵢ is an ionization efficiency correction factor having a positive value between 0 and 1, and m_{ƒ} is a mass fraction factor having a positive value between 0 and 1.

62. The method according to claim 48, wherein the mass flux calibration data or the at least one mass flux calibration curve data is determined by converting dissolved metal calibration data or at least one dissolved metal calibration curve relating a measured intensity to concentration using the following equation:
$$Δ m = {η}_{t} {t}_{d} QC$$
in which ηₜ is a transport efficiency factor correcting for ion losses in the inductively-coupled plasma mass spectrometer, t_{d} is a dwell time or acquisition interval time, Q a sample flow rate of the inductively-coupled plasma mass spectrometer and C a dissolved ion concentration.

63. The method according to claim 48, wherein the intensity -versus-counts histogram is provided by obtaining or measuring intensity measurements representing particle detection as a function of time using a inductively-coupled plasma mass spectrometer, and removing a background intensity signal from the intensity measurements as a function of time.

64. The method according to claim 63, wherein removing the background signal is carried out by averaging over all intensity values and determining a standard deviation, and defining a particle detection as any intensity value that is at least 3 times the standard deviation σ+the mean μ above a background intensity value, and arranging the particle detections based on their respective intensity values and as a counts-versus-intensity histogram.

65. The method according to claim 48, further including the step of providing an inductively-coupled plasma mass spectrometer configured to carry out single-particle inductively coupled plasma mass-spectrometry, or an inductively-coupled plasma mass spectrometer equipped with a microdroplet generator.

66. The method according to claim 48, further including a sample or dilution preparation step comprising using an alkylating agent or weak alkylating agent to carry out surfactant stripping on a plurality of particles to be sized and counted, to remove native surfactants and replace the native surfactants with at least one inorganic counter ion.

67. The method according to claim 48, wherein the method is a computer implemented method.
